(19) United States
(12) Patent Application Publication
(10) Pub. No.: US 2012/0107699 A1
(43) Pub. Date: May 3, 2012

(54) LITHIUM ION BATTERY

(76) Inventor: Takahiro Yamaki, Hitachinaka (JP)

(21) Appl. No.: 13/278,197

(22) Filed: Oct. 21, 2011

(30) Foreign Application Priority Data
Oct. 29, 2010 (JP) 2010-242948

(51) Int. Cl. H01M 10/056; H01M 10/05

(52) U.S. Cl. 429/338; 429/188; 429/199; 429/342

(57) ABSTRACT

A high-voltage lithium ion battery of the present invention has a cathode generating a potential of 4.5 V or higher on the metal lithium basis, an anode, and a nonaqueous electrolyte having a lithium salt dissolved in a nonaqueous solvent. A cathode coating layer is on at least a part of the surface of a cathode material mix and includes boron whose amount is equal to or greater than 0.0001% and equal to or less than 0.005% by weight of the cathode material mix.

### BACKGROUND OF THE INVENTION

The present invention relates to a high-voltage lithium ion battery whose cathode is used at a potential of 4.5 V or higher on the metal lithium basis.

In recent years, there has been a need for lithium ion batteries which are used either as power sources consisting of a number of cells in multiple series in electric vehicles, hybrid electric vehicles, electric power storage equipment, and so on, or as a power supply of a higher energy density and which provide higher voltages than the conventional voltages in the vicinity of 4 V.

The cathode of a high-voltage lithium ion battery has a cathode material which stably generates a potential of 4.5V or higher on the metal lithium basis. Known cathode active materials of this type include transition metal substituted spinel Mn oxides represented by the general formula LiMn₂₋ₓMₓO₄ (M=Ni, Co, Cr, Fe and so on) and olivine-type oxides (common name) given by the general formula LiMPO₄ (M=Ni, Co). A high-voltage lithium ion battery has a high-potential cathode, an anode, and a nonaqueous electrolyte including a lithium salt. The cathode includes the above-described cathode active material, a conductive additive for enhancing the conductivity, and a binder for binding them together.

A nonaqueous electrolyte having a nonaqueous solvent consisting chiefly of a carbonate-based solvent in which a lithium salt is dissolved is widely used in conventional lithium ion batteries generating a voltage in the neighborhood of 4 V. As a specific example, a nonaqueous electrolyte is used which is obtained by dissolving a lithium salt such as lithium hexafluorophosphate (LiPF₆) or lithium tetrafluoroborate (LiBF₄) in a mixture solvent of a cyclic alkyl carbonate of high dielectric constant, such as ethylene carbonate (EC) or propylene alkyl carbonate (PC), and a chain carbonate such as dimethyl carbonate (DMC), diethyl carbonate (DEC), or methyl ethyl carbonate (MEC). One feature of an electrolyte consisting chiefly of such a carbonate-based solvent is that there is a good balance between oxidation resistance and reducibility resistance. Another feature is that it is excellent in transmitting lithium ions. As a lithium salt, an electrolyte in which LiPF₆ is dissolved is excellent in transmitting lithium ions.

However, a lithium ion battery using a high-potential cathode generating a potential of 4.5 V or higher has the problem that the aforementioned carbonate-based solvent is oxidatively decomposed on the surface of the cathode. Consequently, the coulombic efficiency (the ratio of the discharge capacity to the charging capacity) drops due to consumption of an amount of electricity by oxidative decomposition, the internal pressure of the battery rises and the outer casing swells due to gas produced by oxidative decomposition of the solvent, the performance degradation, especially the cycle life shortening, due to the decrease of electrolyte and variation of the components of the electrolyte.

As a prior art technique relative to this problem, JP-A-2004-241339, for example, discloses a lithium ion battery using a solvent in which hydrogen atoms constituting a carbonate have been replaced by a halogen element such as fluorine. Also, JP-A-2002-110225 discloses a lithium ion battery using a room-temperature molten salt.

Another type of prior art technique pertains to countermeasures taken on the cathode side at which oxidative degradation of the solvent progresses. For example, JP-A-2009-218217 discloses a cathode active material for a lithium ion battery, the surface of the active material having a coating layer including a metal element. Furthermore, JP-A-2003-173770 discloses a lithium ion battery having a cathode active material and a conductive additive which are coated with lithium ion-conducting glass.

### SUMMARY OF THE INVENTION

However, the electrolytes using the solvents described in JP-A-2004-241339 and JP-A-2002-110225 have the problem that the reducibility resistance or lithium ion conductivity is poor. In addition, the oxidative decomposition of solvent described in JP-A-2009-218217 progresses also in the conductive additive constituting the cathode. It is obvious that expected effects are not sufficiently obtained from this technique. Also, JP-A-2003-173770 has the problem that the coating with conductive glass greatly hinders the conductivity of lithium ions and impairs the performance of the battery. Additionally, there is the problem that the number of manufacturing steps is increased by the processing of coating of the cathode with the conductive glass.

As described in detail so far, in the lithium ion battery using a high-potential cathode generating a potential of 4.5 V or higher, problems caused by oxidative decomposition of the solvent of the nonaqueous electrolyte, especially decrease of the coulombic efficiency and decrease of the cycle life, are not yet sufficiently solved.

An object of the present invention is to obtain a high-voltage lithium ion battery which is excellent especially in terms of the coulombic efficiency and cycle life.

A lithium ion battery that is one embodiment of the solution of the present invention is a lithium ion battery having: a cathode including a cathode material having a cathode active material stably generating a potential of 4.5 V or higher on the metal lithium basis, a conductive additive, and a binder; an anode; and a nonaqueous electrolyte having a lithium salt dissolved in a nonaqueous solvent. A cathode coating layer including boron is on at least a part of the surface of the cathode material mix, and the amount of boron is equal to or greater than 0.0001% and equal to or less than 0.005% by weight of the cathode material mix. Alternatively, the amount is equal to or greater than 0.02 μg/cm² and equal to or less than 0.8 μg/cm² in the area of the cathode material mix.

More preferably, the anode has an anode material mix including an anode active material and a binder. An anode coating layer including boron is on at least a part of the surface of the anode material mix and the amount of boron is equal to or greater than 0.005% and equal to or less than 0.2% by weight of the anode material mix. Alternatively, the amount is equal to or greater than 0.8 μg/cm² or 30 μg/cm² in the area of the anode material mix.

More preferably, the lithium salt is lithium hexafluorophosphate.

More preferably, the nonaqueous electrolyte consists chiefly of cyclic carbonate and chain carbonate.

Even more preferably, the cyclic carbonate is ethylene carbonate and the chain carbonate has one or more types of dimethyl carbonate and methyl ethyl carbonate.

A still more preferred embodiment has at least a boron fluoride in the cathode coating layer, and has at least a boron oxide or a borofluoroxide in the anode coating layer.

According to the present invention, a high-voltage lithium ion battery having excellent coulombic efficiency and cycle life is obtained.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram illustrating the difference in cyclic voltammetry between when nonaqueous electrolyte includes boron ethoxide and when it does not include it.

FIG. 2 is a schematic cross section of a cylindrical bundle of electrodes of a lithium ion battery of the present embodiment.

### DETAILED DESCRIPTION OF THE EMBODIMENTS

A lithium ion battery that is one embodiment of the present invention has a cathode having a cathode material mix, an anode, and a nonaqueous electrolyte having a lithium salt dissolved in a nonaqueous solvent, the cathode material mix including a cathode active material, a conductive additive, and a binder. The cathode active material generates a potential of 4.5 V or higher on the metal lithium basis. One example of the aspect of the high-potential cathode has a cathode material mix layer on one or both surfaces of an aluminum current collector foil. A cathode coating layer is on at least a part of the surface of the cathode material mix and includes boron whose amount is equal to or greater than 0.0001% and equal to or less than 0.005% by weight of the cathode material mix, or is equal to or greater than 0.02 μg/cm² and equal to or less than 0.8 μg/cm² in the area of the cathode material mix. Consequently, a high-voltage lithium ion battery having excellent coulombic efficiency and cycle life is obtained.

It is conjectured that this action is produced by suppression of direct contact of the solvent of the electrolyte with the cathode active material and conductive additive by the cathode coating layer including a boron compound so that oxidative decomposition of the solvent is suppressed. At the same time, it is conjectured that the presence of the boron compound in the cathode coating layer more effectively suppresses the contact of the solvent with the cathode active material and conductive additive, and further enhance the lithium ion conductivity in the coating layer.

It is expected that the effects is produced only if a part of the surface of the cathode material mix is coated with the cathode coating layer. A more preferred aspect is that the cathode coating layer is present over almost all the region of the cathode material mix.

When the amount of boron in the cathode coating layer is less than 0.0001% by weight of the cathode material mix or is less than 0.02 μg/cm² in the area of the cathode material mix, there is a possibility that oxidative decomposition of the solvent is not suppressed sufficiently or the lithium ion conductivity is impaired. On the other hand, when the amount of boron exceeds 0.005% by weight of the cathode material mix or exceeds 0.8 μg/cm² in the area of the cathode material mix, there is a possibility that the cathode coating layer is thick and the lithium ion conductivity is impaired.

More preferred aspects of the lithium ion battery of the present invention are as follows.

As one aspect of the anode, an anode material mix layer having an anode active material and a binder is on one or both surfaces of current collector foil of copper. An anode coating layer including boron is on at least a part of the surface of the anode material mix. The amount of boron is equal to or greater than 0.005% and equal to or less than 0.2% by weight of the anode material mix, or is equal to or greater than 0.8 μg/cm² and equal to or less than 30 μg/cm² in the area of the anode material mix. Consequently, a high-voltage lithium ion battery having excellent couloumbic efficiency and cycle life is obtained.

It is conjectured that this action is produced by suppression of direct contact of the solvent of the electrolyte with the anode active material by the anode coating layer including a boron compound so that reductive reaction and decomposition of the solvent are suppressed. At the same time, it is conjectured that the presence of the boron compound in the anode coating layer more effectively suppresses the contact of the solvent with the anode active material, and further enhances the lithium ion conductivity in the coating layer.

It is expected that the effects is produced only if a part of the surface of the anode material mix is coated with the anode coating layer. A more preferred aspect is that the anode coating layer is present over almost all the region of the anode material mix.

When the amount of boron in the anode coating layer is less than 0.005% by weight of the anode material mix, or is less than 0.8 μg/cm² in the area of the anode material mix, there is a possibility that reductive reaction of the solvent is not suppressed sufficiently or the lithium ion conductivity is impaired. On the other hand, when the amount of boron exceeds 0.2% by weight of the anode material mix or exceeds 30 μg/cm² in the area of the anode material mix, there is a possibility that the cathode coating layer is thick and the lithium ion conductivity is impaired.

The amounts of boron in the cathode coating layer and in the anode coating layer of the present embodiment can be known, for example, by immersing each electrode in an appropriate solvent to dissolve or extract the boron compound in the coating layers and measuring the amount of boron in the solvent by inductively-coupled plasma spectrometry, atomic absorption photometry, or the like. For example, an aqueous solution of hydrochloric acid can be used as the solvent.

The amount of boron in the cathode coating layer is measured, for example, as follows. The cathode is taken out of the battery and cut into an appropriate size. Then, the cathode is cleaned with a solvent constituting the nonaqueous electrolyte (e.g., dimethyl carbonate) and dried. The dried cathode is immersed in the aqueous solution of hydrochloric acid of known capacity. Then, the concentration of boron in the aqueous solution of hydrochloric acid is measured. The area of the cathode material mix can be known by measuring the dimensions of the cut cathode. Furthermore, the weight of the cathode material mix can be known based on the amount of the cathode material mix applied during the manufacture of the cathode. Alternatively, after the weight of the cut cathode is measured, the cathode material mix is peeled off or removed using acetone, N-methyl-2-pyrrolidone (NMP), or the like, and thus, the weight of the removed cathode material mixture can be known by measuring it.

The amount of boron in the anode coating layer can be known in the same way as for the anode.

No restrictions are imposed on the means for forming the cathode coating layer and anode coating layer including boron. For example, a coating layer may be previously formed on the surface of each material mix of the anode and cathode. Alternatively, a certain boron compound may be added as an additive to an aqueous electrolyte, the additive may be reacted on the surfaces of the cathode and anode, and coating layers including boron may be formed. The latter is preferable because the number of steps for manufacturing the battery is less than the former and because the coating layers can be formed at uniform quality on the surfaces of the mixes.

Preferably, the boron compound (hereinafter referred to as the boron additive) added as the additive oxidatively reacts at the cathode and forms the coating layer. More preferably, the compound oxidatively reacts at a cathode potential of 4.5 V or higher. In addition, the compound is more preferably reduced at the surface of the anode and a coating layer is formed on the anode.

The added boron additives may include two or more types. Preferably, the coating layers on the cathode and anode are made from only one type of boron additive.

One example of such boron additive is boron ethoxide.

Boron ethoxide is represented by the chemical formula B(OC₂H₅)₃. An oxidation reaction of boron ethoxide progresses at a cathode potential of about 4.5 V or higher and forms a cathode coating layer including boron on the surface of the cathode material mix.

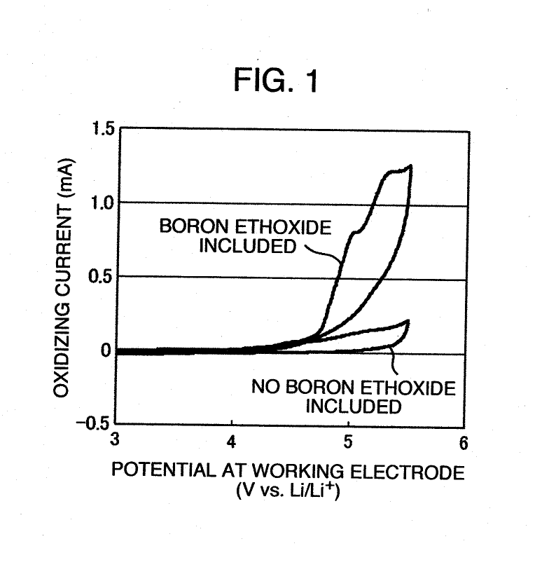

FIG. 1 represents a difference in cyclic voltammetry between when there is boron ethoxide, i.e., 4% by weight of boron ethoxide is added to a nonaqueous electrolyte consisting of a nonaqueous mixed solvent mixed with ethylene carbonate, dimethyl carbonate, and methyl ethyl carbonate at a volume ratio of 2:4:4 and in which 1 mol/dm³ of lithium hexafluorophosphate as a lithium salt has been dissolved and when there is no such boron ethoxide. It can be seen that when there is boron ethoxide, the oxidation current increases more rapidly at about 4.5 V or greater than when there is no boron ethoxide.

After an oxidation reaction of boron ethoxide at the surface of the cathode, a reductive reaction of at least some of the reaction products progresses at the surface of the anode, forming an anode coating layer including boron on the surface of the anode material mix.

It is considered here that in a case where the cathode potential is lower than 4.5 V, the boron ethoxide does not oxidize on the surface of the cathode or its oxidation reaction hardly progresses. Accordingly, it is considered that almost no boron is present in the cathode coating layer. At the same time, it is considered that boron derived from oxidation products of boron ethoxide is hardly present in the anode coating layer.

The morphology of the boron compound in the cathode coating layer and anode coating layer formed based on boron ethoxide is not always clear. However, it is considered that in the cathode coating layer, at least borofluoxides having bonding between boron and fluorine are present. It is considered, on the other hand, that in the anode coating layer, at least boron oxides having bonding between boron and fluorine or borofluoroxides having bonding among boron, oxygen, and fluorine are present.

The morphology of such boron compound in the coating layers can be estimated based on the analysis results of an appropriate instrumental analysis. For example, a time-of-flight ion mass spectrometry or the like can be used as such instrumental analysis means.

With respect to lithium salts constituting the nonaqueous electrolyte, LiClO₄, LiCF₃SO₃, LiPF₆, LiBF₄, LiAsF₆, and so on can be used alone or in combination. Lithium hexafluorophosphate (LiPF₆) that exhibits better lithium ion conductivity with increasing degree of dissociation is more preferable.

By using the cyclic carbonate and the chain carbonate in or as the nonaqueous solvent constituting the nonaqueous electrolyte, the lithium ion conductivity and the reducibility resistance of lithium ions in the nonaqueous electrolyte can be enhanced, which is more desirable.

More preferably, the cyclic carbonate constituting the nonaqueous electrolyte is ethylene carbonate and the chain carbonate is made of one or more types of dimethyl carbonate and methyl ethyl carbonate, and thereby the lithium ion conductivity and reducibility resistance can be enhanced further.

Besides, propylene carbonate, butylene carbonate, diethyl carbonate, methyl acetate, and so on can be used as the nonaqueous solvent.

Further, various kinds of additives can be added to the nonaqueous electrolyte within the range in which the object of the present invention is not hindered. For instance, in order to impart fire retardancy, ester phosphate or the like can be added.

The lithium ion battery of the present embodiment is built by the high-potential cathode generating a potential of 4.5 V or higher on the metal lithium basis, nonaqueous electrolyte, and anode according to the present embodiment described so far.

The high-potential cathode of the present embodiment has a cathode active material stably generating a potential of 4.5 V or higher on the metal lithium basis.

Cathode active materials include spinel-type oxides represented by the general formula LiMn₂₋ₓM_{X}O₄ and olivine-type oxides (ordinary name) represented by the general formula LiMPO₄ (M=Ni, Co). However, no restrictions are placed. Spinel-type oxides of the compositional formula Li₁₊ₐMn_{2-a-x-y}NiₓM_{y}O₄ (0≦a≦0.1, 0.3≦x≦0.5, 0≦y≦0.2; M is at least one kind of Cu, Co, Mg, Zn, and Fe) are preferable because they generate potentials of 4.5 V or higher stably and with high capacities.

The high-potential cathode of the present embodiment is fabricated using the cathode active material, conductive additive, and binder.

A carbon material such as carbon black, hard carbon, soft carbon, or graphite can be used as the conductive additive. It is preferable that carbon black is used, and according to the need, hard carbon may be used.

As the binder, a high-polymer material such as polyvinylidene fluoride, polytetrafluoroethylene, polyvinyl alcohol derivative, cellulose derivative, or butadiene rubber can be used. To prepare the cathode, these binders can be used by dissolving them in a solvent such as N-methyl-2-pyrrolidone (NMP) and.

Solutions in which a cathode active material, a conductive additive, and a binder are respectively dissolved are metered so as to obtain a desired mix composition, and mixed to prepare a slurry of the cathode material mix. The slurry is applied to a current collector foil such as aluminum foil and dried. Then, the dried material is molded with a press or the like and cut into a desired size. Thus, the high-potential cathode is prepared.

The anode used in the lithium ion battery of the present embodiment is configured as follows.

No restrictions are placed on the anode active material. Various carbon materials, metal lithium, lithium titanate, oxides of tin, silicon, and so on, metals that can be alloyed with lithium such as tin and silicon, and composites thereof can be used. Especially, carbon materials such as graphite, soft carbon, and hard carbon generate low voltages and are excellent in cycleability and so these materials are preferred as anode active materials used in the high-voltage lithium ion battery of the present embodiment.

Solutions in which an anode active material and a binder are respectively dissolved and a conductive additive such as carbon black if necessary are metered so as to obtain a desired mix composition and mixed to prepare a slurry of the anode material mix. The slurry is applied to current collector foil such as copper foil and dried. Then, the dried material is molded with a press or the like and cut into a desired size. Thus, the anode is prepared.

Using the cathode, anode, and nonaqueous electrolyte of the present embodiment as described so far, lithium ion batteries of the present embodiment which have shapes of a button, a cylinder, a rectangular form, a laminate form, and so on are fabricated.

The cylindrical battery is fabricated as follows. A cathode and an anode having terminals cut into strips and used for taking out electrical currents are used. A separator consisting of a porous insulator film having a thickness of 15 to 50 μm is inserted between the cathode and the anode. This structure is wound into a cylindrical form to fabricate a bundle of electrodes and contained in a container made of SUS or aluminum. A resinous porous insulator film such as polyethylene, polypropylene, aramid, or the like can be used as the separator. A layer of an inorganic compound such as alumina may be formed on the film.

A cylindrical lithium ion battery is fabricated by injecting a nonaqueous electrolyte into the container holding the bundle of electrodes therein within dry air or within a working vessel having an inert gas ambient and sealing the container.

To make a rectangular battery, it is fabricated, for example, as follows. In the above-described winding, two axes used, and an elliptical bundle of electrodes is fabricated. In the same way as in the cylindrical lithium ion battery, the bundle is contained in a rectangular container, an electrolyte is injected, and then the container is sealed off. Instead of the winding, a set of electrodes obtained by stacking a separator, a cathode, a separator, an anode, and a separator in this order may also be used.

To make a laminate battery, it is fabricated, for example, as follows. The above-described stack of electrodes is housed in a baglike aluminum laminate sheet lined with insulator sheet made of polyethylene or polypropylene. The terminals of the electrodes are made to protrude from the openings. Under this condition, an electrolyte is injected and then the openings are sealed off.

No restrictions are imposed on the application of the lithium ion battery of the present embodiment. Because of its high battery voltage, the battery is preferably used as a power supply in applications where a plurality of batteries are connected in multiple series in use. For example, the battery can be used as a power supply for providing motive power for an electric vehicle, hybrid electric vehicle, or the like, industrial equipment such as an elevator having a system that recovers at least a part of kinetic energy, and as a power supply for an electrical power storage system used in various business applications or household applications.

For other applications, the battery can also be used as a power supply for various portable devices, information devices, household electrical machines, power tools, and so on.

Detailed embodiments of the lithium ion battery of the present embodiment are hereinafter shown and described in detail. Note that the present invention is not restricted to the embodiments described below.

### EMBODIMENTS

Batteries A, B, and C that are batteries of the present embodiment were fabricated as follows.

LiMn_{1.52}Ni_{0.48}O₄ was prepared as a cathode active material generating a potential of 4.5 V or higher on the metal lithium basis.

As raw materials, manganese dioxide (MnO₂) and nickel oxide (NiO) were metered to give a given compositional ratio. The materials were wet mixed using pure water. After being dried, the mixture was sintered within an ambient of air using an electric furnace at a temperature rise rate of 3° C./min and a temperature drop rate of 2° C./min at 1,000° C. for 12 hours. The sintered body was pulverized. Then, lithium carbonate (Li₂CO₃) metered to a given compositional ratio to that was similarly wet mixed and dried. Then, the mixture was sintered within an ambient of air at a temperature rise rate of 3° C./min and a temperature drop rate of 2° C./min at 800° C. for 20 hours. The sintered body was pulverized to obtain a cathode active material.

Then, 91% by weight of the cathode active material, 3% by weight of carbon black, and 6% by weight of polyvinylidene fluoride (PVDF) being a binder were dissolved in N-methyl-2-pyrrolidone (NMP). The solutions were mixed to prepare a slurry of cathode material mix. The slurry of the cathode material mix was applied to one surface of aluminum foil (cathode current collector foil) having a thickness of 20 μm and dried. Then, the slurry was similarly applied to the rear surface and dried. The weight of the dried mix was about 15 mg/cm² per surface. Then, the dried mix was cut into a size having a width of 54 mm and a length of 600 mm such that one side in the longitudinal direction was not applied with the slurry. The mix was compressed and molded to a given mix density with a press. Then, a cathode terminal of aluminum was welded to the unapplied portion, thus the cathode was fabricated.

Next, an anode was fabricated.

First, 92% by weight of artificial graphite being an anode active material and 8% by weight of PVDF were dissolved in NMP. The solutions were mixed to prepare a slurry of anode material mix. The slurry of the anode material mix was applied to one surface of copper foil (anode current collector foil) having a thickness of 15 μm and dried. The slurry was similarly applied to the rear surface and dried. The weight of the dried mix was about 7 mg/cm² per surface. Then, the dried mix was cut into a size having a width of 56 mm and a length of 650 mm such that one side in the longitudinal direction was not applied with the slurry. The mix was compressed and molded to a given mix density with a press. Then, an anode terminal of nickel was welded to the unapplied portion, thus the anode was fabricated.

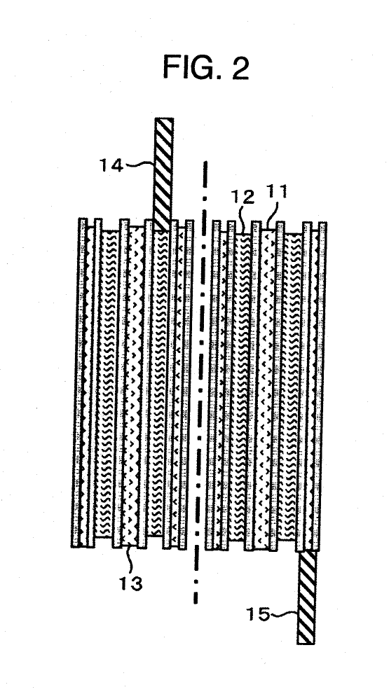

Using the fabricated cathode and anode, a cylindrical bundle of electrodes of the lithium ion battery schematically illustrated in FIG. 2 was fabricated. A porous separator 11 having a thickness of 30 μm of polypropylene was inserted, and the cathode 12 and the anode 13 were wound. At this time, the cathode terminal 14 and the anode terminal 15 were made to face in opposite directions. The fabricated bundle of electrodes was impregnated with 5 cm³ of nonaqueous electrolyte and contained in a cylindrical laminate sheet of alumina lined with polyethylene in an ambient of argon gas. The cathode and anode terminals were made to protrude from the openings at both ends and then the openings were sealed off. Thus, the battery was fabricated.

The nonaqueous electrolyte was prepared as follows. A nonaqueous mixed solvent containing ethylene carbonate, dimethyl carbonate, and methyl ethyl carbonate at a volume ratio of 2:4:4 was prepared. Then, 1 mol/dm³ of a lithium salt (hexafluorophosphate) was dissolved in the mixed solvent. Then, 0.2% (battery A) by weight, 1% by weight (battery B), and 4% by weight (battery C) of boron ethoxide (B(OC₂H₅)₃) were respectively added to the solvent.

### Comparative Examples

As comparative examples, a battery D using an electrolyte to which 6% by weight of boron ethoxide was added and a battery Z using an electrolyte to which no boron ethoxide was added were fabricated similarly to the embodiments except for the aforementioned difference.

### (Charging and Discharging Tests)

Charging and discharging tests were performed using each two cells of the fabricated battery cells of the embodiments and comparative examples. The charging conditions were as follows. Each cell was charged with a constant current at a time rate of ⅕ CA to a final voltage of 4.85 V. Immediately thereafter, constant-voltage charging was done for 1 hour at a voltage of 4.85 V. After the charging, the circuit was kept opened for 30 minutes. The discharging conditions were as follows. Each cell was discharged with a constant current at a time rate of ⅕ CA to a final voltage of 3 V. After the discharging, the circuit was kept opened for 30 minutes. A set of the charging and discharging as described so far was defined as one cycle.

Each battery cell of the examples and comparative examples was tested up to 5 cycles and subjected to a measurement of the amount of boron. The other cells, one for each example, were tested up to 40 cycles. The discharge capacity of each battery cell after 1 cycle and charge capacity and discharge capacity after 40 cycles were measured.

### (Measurement of Amount of Boron)

The amounts of boron in the cathode coating layer and in the anode coating layer of each fabricated battery cell of the examples and comparative examples were measured.

The amount of boron in the cathode coating layer was measured as follows.

The bundle of electrodes was taken out of each battery cell undergone 5 cycles of charging and discharging tests within an ambient of argon gas. Furthermore, the cathode was taken from the bundle of electrodes. A piece of the cathode having a length of 30 cm was cut out. The cathode piece was cleaned in dimethyl carbonate and dried. Then, the piece was moved into the air and immersed in 20 cm³ of aqueous solution of hydrochloric acid of 1 mol/dm³ at room temperature. The solution was slowly stirred and the piece was taken out after 15 minutes. The boron concentration of the aqueous solution of the hydrochloric acid was measured by the inductively-coupled plasma spectrometry.

The amount of boron in the anode coating layer was measured similarly to the case of the anode.

The amount of boron in the coating layer of each of the electrode pieces (cathode piece and anode piece) was derived from Eq. (1).

(amount of boron in electrode piece)=(amount of aqueous solution of hydrochloric acid)×(concentration of boron in aqueous solution of hydrochloric acid) (Eq. 1)

The amount of boron in the coating layer per unit area of the mix was found from Eq. (2).

$$( amount of boron per unit area of mix ) = \frac{( amount of boron in electrode piece )}{\begin{matrix}( length of electrode piece ) \times \\ ( width of electrode piece ) \times 2\end{matrix}} \qquad ( Eq . 2 )$$

Here, since the material mix is applied to the both surfaces of the current collector foil, the area of the mix is twice as large as the area of the electrode piece.

Furthermore, the amount of boron in the coating layer per unit weight of the mix was found from Eq. (3).

$$( amount of boron per unit weight of mix ) = \frac{( amount of boron per unit area of mix )}{( amount of mix applied to one surface )} \times 100 ( weight \% ) \qquad ( Eq . 3 )$$

Table 1 shows the amounts of boron (per unit weight of mix and per unit area of mix) in each of the cathode coating layer and the anode coating layer of each battery cell of the examples and comparative examples, the ratio of the discharge capacity after 40 cycles to the discharge capacity after 1 cycle, and the coulombic efficiency after 40 cycles (ratio of the discharge capacity to the charging capacity).

TABLE 1

| | | amount of boron in | | amount of boron in | | | |
|---|---|---|---|---|---|---|---|
| | | cathode coating layer | | anode coating layer | | | |
| | | per unit | per unit | per unit | per unit | | cycle |
| | | weight of | area of | weight of | area of | cycle | coulombic |
| | | mix | mix | mix | mix | capacity | efficiency |
| | battery | (weight %) | (μg/cm²) | (weight %) | (μg/cm²) | (%) | (%) |
| Examples | battery A | 0.00019 | 0.026 | 0.0059 | 0.81 | 85.7 | 99.27 |
| | battery B | 0.0013 | 0.17 | 0.048 | 6.3 | 86.5 | 99.39 |
| | battery C | 0.0047 | 0.71 | 0.19 | 29 | 86.3 | 99.18 |
| Comparative | battery D | 0.0068 | 0.98 | 0.27 | 38 | 83.8 | 98.59 |
| Examples | battery Z | below | below | below | below | 79.3 | 96.61 |
| | | detection | detection | detection | detection | | |
| | | limit | limit | limit | limit | | |

The batteries of the examples indicated advantages that they have higher discharge capacity and coulombic efficiency after 40 cycles than the batteries of the comparative examples, thus being excellent in cycle life.

The amount of boron in the cathode coating layer of each battery of the examples having excellent cycle life is in the range from 0.0001% to 0.005% by weight of the cathode material mix and in the range from 0.02 μg/cm² to 0.8 μg/cm² in the area of the cathode material mix. In all the batteries of the comparative examples, the amounts are outside the ranges. The amount of boron in the cathode coating layer of each battery of the embodiments is in the range from 0.005% to 0.2% by weight of the anode material mix and in the range from 0.8 μg/cm² to 30 μg/cm² in the area of the anode material mix. In all the batteries of the comparative examples, the amounts are outside the ranges.

### Reference Examples

Batteries M and N using LiMn_{1/3}Ni_{1/3}CO_{1/3}O₂ that is a cathode active material operating at a potential of less than 4.5 V on the metal lithium basis were fabricated as reference examples in the same way as the examples. The battery M used an electrolyte to which no boron ethoxide was added. The battery N used an electrolyte to which 1% by weight of boron ethoxide was added.

Using the fabricated batteries of the reference examples, charging and discharging tests similar to the tests for the examples were conducted up to 40 cycles. The charging conditions were as follows. Constant-current charging was conducted at a charging current at a time rate of ⅕ CA to a final voltage of 4.1 V. Immediately thereafter, constant-voltage charging was done at a voltage of 4.1 V for 1 hour. The final voltage of the discharging was 2.7 V.

Table 2 shows the ratio of the discharge capacity after 40 cycles to the discharge capacity after 1 cycle and coulombic efficiencies of each battery of the reference examples.

TABLE 2

| | | cycle | cycle coulombic |
|---|---|---|---|
| | battery | capacity (%) | efficiency (%) |
| reference | battery M | 96.4 | 99.83 |
| examples | battery N | 95.7 | 99.74 |

The battery N to which boron ethoxide was added was slightly lower in the discharge capacity after 40 cycles and in the coulombic efficiency than the battery M to which no boron ethoxide was added. There was no effect on the cycle life.

It should be further understood by those skilled in the art that although the foregoing description has been made on embodiments of the invention, the invention is not limited thereto and various changes and modifications may be made without departing from the spirit of the invention and the scope of the appended claims.

1. A lithium ion battery comprising:
a cathode including a cathode material mix having a cathode active material generating a potential of 4.5 V or higher on a metal lithium basis, a conductive additive, and a binder;
an anode; and
a nonaqueous electrolyte having a lithium salt dissolved in a nonaqueous solvent;
wherein a cathode coating layer is on at least a part of a surface of the cathode material mix and includes boron whose amount is equal to or greater than 0.0001% and equal to or less than 0.005% by weight of the cathode material mix, or is equal to or greater than 0.02 μg/cm² and equal to or less than 0.8 μg/cm² in the area of the cathode material mix.

2. The lithium ion battery of claim 1, wherein the anode has an anode material mix including an anode active material and a binder, and wherein an anode coating layer is on at least a part of a surface of the anode material mix and includes boron whose amount is equal to or greater than 0.005% and equal to or less than 0.2% by weight of the anode material mix.

3. The lithium ion battery of claim 1, wherein the anode has an anode material mix including an anode active material and a binder, and wherein an anode coating layer is on at least a part of a surface of the anode material mix and includes boron whose amount is equal to or greater than 0.8 μg/cm² and equal to or less than 30 μg/cm² in the area of the anode material mix.

4. The lithium ion battery of claim 1, wherein the lithium salt is lithium hexafluorophosphate.

5. The lithium ion battery of claim 1, wherein the nonaqueous solvent consists chiefly of cyclic carbonate and chain carbonate.

6. The lithium ion battery of claim 5, wherein the cyclic carbonate is ethylene carbonate, and wherein the chain carbonate has one or more types of dimethyl carbonate and methyl ethyl carbonate.

7. The lithium ion battery of claim 2, wherein the cathode coating layer has at least a boron fluoride, and wherein the anode coating layer has at least a boron oxide or a borofluoroxide.
